(19) United States
(12) Patent Application Publication
(10) Pub. No.: US 2025/0156844 A1
(43) Pub. Date: May 15, 2025

(54) TECHNIQUES TO STORE AND PROCESS DATA FOR TRANSACTION ATTEMPTS BY TRANSACTION CARDS

(71) Applicant: Capital One Services, LLC, McLean, VA (US)

(72) Inventor: Jeffrey Rule, Chevy Chase, MD (US)

(73) Assignee: Capital One Services, LLC, McLean, VA (US)

(21) Appl. No.: 18/922,964

(22) Filed: Oct. 22, 2024

Related U.S. Application Data
(63) Continuation of application No. 16/863,437, filed on Apr. 30, 2020, now abandoned.

(51) Int. Cl. G06Q 20/34; G06Q 20/20; G06Q 20/32; G06Q 20/38

(52) U.S. Cl. CPC G06Q 20/352; G06Q 20/20; G06Q 20/3278; G06Q 20/382

(57) ABSTRACT

Embodiments may be generally directed to techniques and systems to detect errors and anomalies in contactless transaction processing. These systems may include transaction cards, point-of-sale (POS) terminals, and transaction processing systems.

### CROSS-REFERENCE TO RELATED APPLICATIONS

This application is a continuation of U.S. patent application Ser. No. 16/863,437, filed Apr. 30, 2020, this disclosure of which is incorporated herein by reference in its entirety.

### BACKGROUND

Payment cards, such as credit cards and debit cards, are very widely used for all forms of financial transactions. The use of payment cards has evolved significantly with technological developments over recent years. Originally, transactions were on paper, using an imprint of a transaction card and confirmed by a signature. This approach was largely replaced by the use of a magnetic stripe of a transaction card swiped through a magnetic stripe reader on a point of sale (POS) terminal to perform a transaction. Transaction cards developed to contain an integrated circuit (“chip cards” or “smart cards”) communicate with a smart card reader in the POS terminal. Using this approach, a transaction is typically confirmed by a personal identification number (PIN) entered by the card user. Cards of this type typically operate under the EMV standard for interoperation of chip cards and associated apparatus (such as POS terminals and ATMs). ISO/IEC 7816 provides a standard for operation of cards of this type.

Technology has further developed to provide payment cards which operate contactlessly. Using such cards, the account number can be read automatically from the card by a POS terminal, generally using a short-range wireless technology such as Radio Frequency Identification (RFID). One specific type of contactless transaction utilizes near-field communication (NFC). However, NFC and other RF approaches to perform transactions have struggled to be adopted for one reason or another. For example, users may not feel conformability or know how to perform a transaction with NFC or transaction terminals may not be configured correctly. Embodiments discussed herein a generally directed to determine issues with respect to contactless transaction attempts.

### BRIEF SUMMARY

Embodiments may be generally directed to techniques and systems to detect errors and anomalies in contactless transaction processing. These systems may include transaction cards, point-of-sale (POS) terminals, and transaction processing systems. For example, embodiments may include a transaction card, including a plurality of interface a processor, a memory storing instructions. In embodiments, the processor may process the instructions to detect a transaction attempt via an interface of the plurality of interfaces, determine data associated with the transaction attempt, the data comprising a timestamp associated with the transaction attempt, and an interface type of the interface on which the transaction attempt was detected, and store the data associated with the transaction attempt in the memory. The processor may also detect a read for the data by a computing device made via an interface of the plurality interfaces, generate encrypted data from the data associated with the transaction attempt stored in the memory, and provide the encrypted data to the computing device via the interface on which the read was detected.

Embodiments may also include a transaction processing system including a processor, storage comprising a data store, and a memory storing instructions. The processor may process the instructions to process received data associated with a plurality of transaction attempts performed with a transaction card associated with a user account, the data comprising entries associated with the transaction attempts, each entry for each transaction attempt including a timestamp for the transaction attempt, and an interface type for the transaction attempt, store the data in the data store, determine interface information for one or more interfaces of the transaction card based on the data, the interface information to indicate anomalies and interface usage statistics associated with the one or more interfaces, and cause an action based on the interface information.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a computing system 100 in accordance with one embodiment.

FIG. 2 illustrates a transaction card 102 in accordance with one embodiment.

FIG. 3 illustrates a transaction card component 300 in accordance with one embodiment.

FIG. 4 illustrates a sequence flow 400 in accordance with one embodiment.

FIG. 5 illustrates an NDEF message 500 in accordance with one embodiment.

FIG. 6 illustrates a logic flow 600 in accordance with one embodiment.

FIG. 7 illustrates a logic flow 700 in accordance with one embodiment.

FIG. 8 illustrates a data 800 in accordance with one embodiment.

FIG. 9 illustrates a computer architecture 900 in accordance with one embodiment.

FIG. 10 illustrates a communications architecture 1000 in accordance with one embodiment.

### DETAILED DESCRIPTION

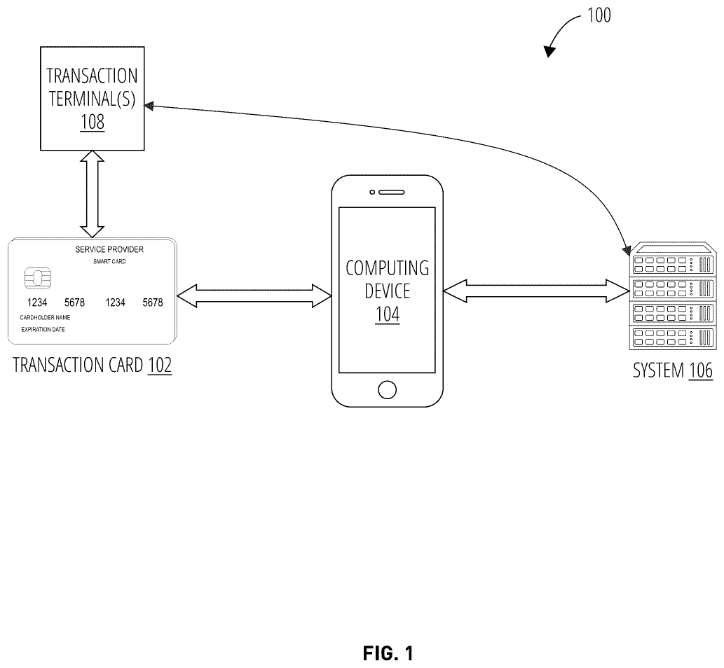

FIG. 1 illustrates an example configuration of a computing system 100 to process and communicate data associated with transactions and to detect issues with one or more components of a transaction processing system. The computing system 100 may include a number of systems, devices, and so forth including a transaction system 106, a computing device 104, a transaction card 102, and one or more transaction terminal(s) 108. The components may be coupled via one or more network connections including wired and wireless network connections to communicate data. Note that computing system 100 illustrates a limited number of components and connections for simplistic purposes, and the computing system 100 may include additional computing and communication components that are not illustrated.

In embodiments, the computing system 100 may be part of a banking system or a transaction processing system where users are enabled to use transaction cards to make purchases for goods or services. For example, a user may use a transaction card 102 at a transaction terminal(s) 108 or a point-of-sale (POS) terminal by inserting the transaction card 102 in the transaction terminal(s) 108, swiping the transaction card 102 on the transaction terminal(s) 108, and/or tapping the transaction card 102 on the transaction terminal(s) 108. The transaction terminal(s) 108 may communicate with a transaction system 106 to process the transaction. These actions may cause data to be communicated between the transaction card 102, the transaction terminal(s) 108, and/or the transaction system 106. For example, the transaction terminal(s) 108 may include a Europay, Mastercard, Visa (EMV) interface capable of coupling with an EMV interface of the transaction card 102 to exchange data to perform a transaction. In another example, the transaction terminal(s) 108 may include a magstripe interface configured to read a magstripe of the transaction card 102 to perform the transaction. In a third example, the transaction card 102 may be configured with a near-field communication (NFC) interface configured to couple and communicate wirelessly with an NFC interface of the transaction card 102 to perform a transaction. In normal operation, the transaction terminal(s) 108 may exchange the data and information with the transaction card 102 and perform a verification/validation routine with the transaction system 106 to perform the transaction.

In some instances, a transaction attempt may fail for one reason or another, e.g., failed verification/validation, corrupt data, bad data read, interference, incorrectly configured terminal, etc. Typically, a user may be aware of the failed transaction attempt, but may not know the cause. In other instances, a user may not even be aware of the transaction attempt. Thus, embodiments are directed to enabling a transaction card 102 to collect data associated with each transaction attempt and providing the data to the transaction system 106 to detect failures and notify customers and operators of transaction terminal(s) 108.

In embodiments, the transaction card 102 may include an applet configured to collect data for each transaction attempt. The data may be collected based on information in memory of the card and/or communicated with a transaction terminal. The transaction card 102 may, from time-to-time, send the collected data to another device to provide to a system to analyze the data. For example, the transaction card 102 may be configured to exchange information, such as the collected data, with computing device 104, which may be a mobile phone device. The computing device 104 may be configured to exchange the information with the transaction system 106, including sending the collected data to the transaction system 106. The collected data may include information for each of the transaction attempts, such as a timestamp a time for the transaction attempt, a transaction identifier to identify the transaction attempt, a transaction terminal identifier to identify a transaction terminal for the transaction attempt, an interface type to identify the interface used for the transaction attempt, and so forth.

In embodiments, the transaction system 106 may perform data analysis routines on data collected by transaction cards and transaction terminals. A data analysis routine may determine usage statistics based on the data, such as a number of times a user or customer encounter contactless (NFC) transaction terminals, a number of times a user takes advantage of the contactless NFC transaction terminal with a contactless (NFC) payment, a number of times a customer encounters a contactless payment terminal and falls back to a contact (EMV/Swipe) payment, and a number of times a transaction attempt fails to indicate a user “gave up.” This data may be used to detect issues with transaction cards and/or transaction terminals.

In embodiments, the transaction system 106 may utilize the usage statistics to provide insights to users and owners of transaction cards and transaction terminals. In some instances, the data analysis routine may be used to determine detailed insights and detect patterns. For example, a data analysis routine recognizes a pattern of usage such as a user attempting to utilize the NFC interface to perform the transaction, the transaction attempt failing, and the user switching to another method (swipe or EMV interface) to perform the transaction. This pattern may be detected based on consecutive transaction attempts having close timestamps (within a configurable reattempt transaction threshold) at a transaction terminal multiple times for the transaction card, e.g., an attempt corresponding to an NFC interface and one corresponding to an EMV interface. The transaction system may determine that there is an anomaly or an issue with the NFC interface with the transaction card if the pattern occurs with the same transaction card at different transaction terminals.

Similarly, the transaction system 106, based on a data analysis routine, may determine there is an issue with a transaction terminal if a similar pattern is detected at the same transaction terminal, but with different transaction cards. More specifically, the transaction system 106 may detect consecutive transaction attempts having close timestamps at a transaction terminal multiple times for multiple transaction cards (above a configurable reattempt transaction threshold).

In embodiments, the transaction system 106 may detect anomalies based on other statistics. For example, if a user uses his/her transaction card's NFC interface statistically less than other like users, e.g., the same area, gender, age group, etc. The transaction system 106 may determine that there is an issue with the customer's transaction card or the customer needs instructions on how to perform a transaction using the contactless NFC interface. In another example, the transaction system may determine there is an issue or anomaly with a transaction terminal if it is being used in a statistically different way than like terminals, e.g., in the same location, same type of place/establishment, etc.

The transaction system 106 may perform a data analysis routine, including applying machine learning on the data include scoring the data with a model to detect anomalies with the transaction cards and/or transaction terminals. For example, the data analysis routine may include applying supervised or unsupervised machine-learning techniques to detect patterns in the data that may indicate an issue with a transaction card or terminal. The machine-learning may include training one or more models with known data set (created/generated) or with real data sets to detect the patterns. Embodiments are not limited in this manner.

In embodiments, the transaction system 106 may cause one or more actions based on the detection of the anomaly or issue based on the data analysis routine applied to the data. For example, the transaction system 106 may cause a new transaction card to be issued to a user if the system determines an issue with an interface for a transaction card. In another example, the transaction system may send instructions on a proper way to use an NFC interface if the system determines that the NFC interface is working properly, but the user appears to not know how to use it correctly, e.g., based on periodic successful attempts. In a third example, the transaction system may send an indication to an operator of a transaction terminal, indicating that an interface is malfunctioning and/or is incorrectly configured. Embodiments are not limited to these examples, and other remedial operations may be performed.

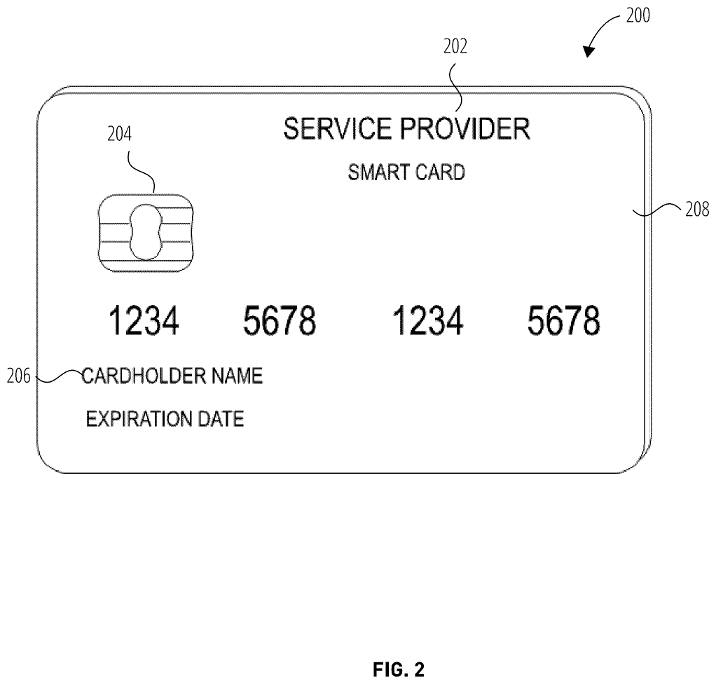

FIG. 2 illustrates an example configuration of a transaction card 200, which may include a contactless card, a payment card, such as a credit card, debit card, or gift card, issued by a service provider as displayed as service provider indicia 202 on the front or back of the transaction card 200. In embodiments, the transaction card 200 is the same as transaction card 102 illustrated in FIG. 1. In some examples, the transaction card 200 is not related to a payment card and may include, without limitation, an identification card. In some examples, the transaction card 200 may include a dual interface contactless payment card, a rewards card, and so forth. The transaction card 200 may include a substrate 208, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the transaction card 200 may have physical characteristics compliant with the ID-1 format of the ISO/IEC 7816 standard, and the transaction card 200 may otherwise be compliant with the ISO/IEC 14443 standard. However, it is understood that the transaction card 200, according to the present disclosure, may have different characteristics, and the present disclosure does not require a transaction card 200 to be implemented in a payment card.

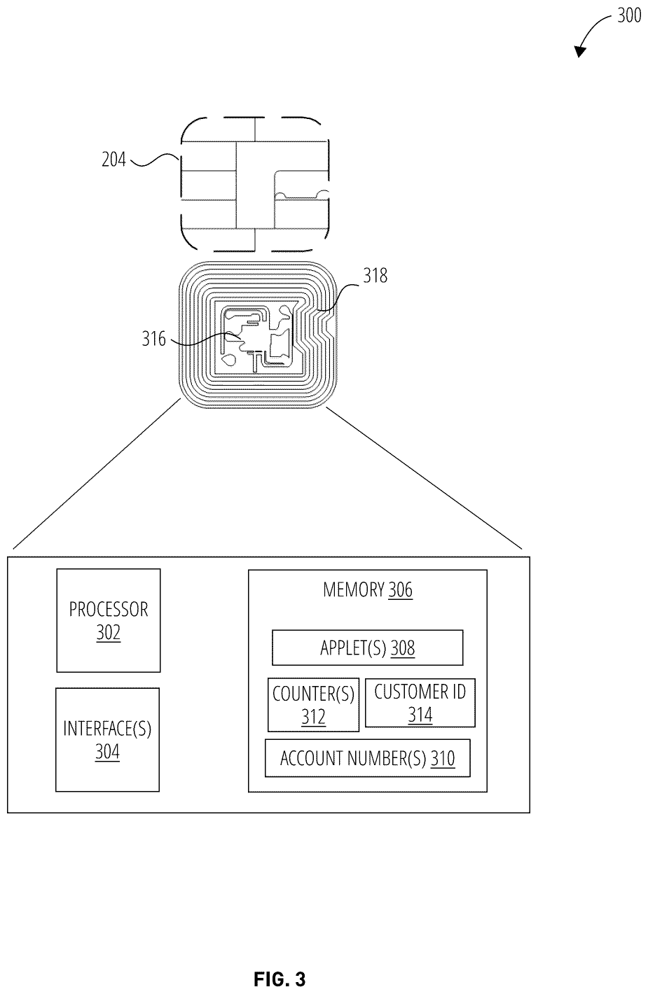

The transaction card 200 may also include identification information 206 displayed on the front and/or back of the card, and a contact pad 204. The contact pad 204 may include one or more pads and be configured to establish contact with another client device, such as an ATM, a user device, smartphone, laptop, desktop, a transaction terminal, a POS terminal, or tablet computer via transaction cards. The contact pad 204 may be designed in accordance with one or more standards, such as ISO/IEC 7816 standard, and enable communication in accordance with the EMV protocol. The transaction card 200 may also include processing circuitry, antenna and other components as will be further discussed in FIG. 3. These components may be located behind the contact pad 204 or elsewhere on the substrate 208, e.g., within a different layer of the substrate 208, and may electrically and physically coupled with the contact pad 204. The transaction card 200 may also include a magnetic strip or tape, which may be located on the back of the card (not shown in FIG. 2). The transaction card 200 may also include a Near-Field Communication (NFC) device coupled with an antenna capable of communicating via the NFC protocol. Embodiments are not limited in this manner.

As illustrated in FIG. 3, the contact pad 204 of the transaction card 200 may include processing circuitry 316 for storing, processing, and communicating information, including a processor 302, a memory 306, and one or more interface(s) 304. It is understood that the processing circuitry 316 may contain additional components, including processors, memories, error and parity/CRC checkers, data encoders, anticollision algorithms, controllers, command decoders, security primitives and tamperproofing hardware, as necessary to perform the functions described herein.

The memory 306 may be a read-only memory, write-once read-multiple memory or read/write memory, e.g., RAM, ROM, and EEPROM, and the transaction card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 306 may be encrypted memory utilizing an encryption algorithm executed by the processor 302 to encrypted data.

The memory 306 may be configured to store one or more applet(s) 308, one or more counter(s) 312, a customer identifier 314, and the account number(s) 310, which may be virtual account numbers. The one or more applet(s) 308 may comprise one or more software applications configured to execute on one or more contactless cards, such as a Java® Card applet. However, it is understood that applet(s) 308 are not limited to Java Card applets, and instead may be any software application operable on contactless cards. The one or more counter(s) 312 may comprise a numeric counter sufficient to store an integer. The customer identifier 314 may comprise a unique alphanumeric identifier assigned to a user of the transaction card 200, and the identifier may distinguish the user of the contactless card from other contactless card users. In some examples, the customer identifier 314 may identify both a customer and an account assigned to that customer and may further identify the transaction card 200 associated with the customer's account. As stated, the account number(s) 310 may include thousands of one-time use virtual account numbers associated with the transaction card 200. An applet(s) 308 of the transaction card 200 may be configured to manage the account number(s) 310 (e.g., to select an account number(s) 310, mark the selected account number(s) 310 as used, and transmit the account number(s) 310 to a mobile device for autofilling by an autofilling service.

The processor 302 and memory elements of the foregoing exemplary embodiments are described with reference to the contact pad 204, but the present disclosure is not limited thereto. It is understood that these elements may be implemented outside of the contact pad 204 or entirely separate from it, or as further elements in addition to processor 302 and memory 306 elements located within the contact pad 204.

In some examples, the transaction card 200 may comprise one or more antenna(s) 318. The one or more antenna(s) 318 may be placed within the transaction card 200 and around the processing circuitry 316 of the contact pad 204. For example, the one or more antenna(s) 318 may be integral with the processing circuitry 316 and the one or more antenna(s) 318 may be used with an external booster coil. As another example, the one or more antenna(s) 318 may be external to the contact pad 204 and the processing circuitry 316.

In an embodiment, the coil of transaction card 200 may act as the secondary of an air-core transformer. The terminal may communicate with the transaction card 102 by cutting power or amplitude modulation. The contactless card 101 may infer the data transmitted from the terminal using the gaps in the contactless card's power connection, which may be functionally maintained through one or more capacitors. The transaction card 102 may communicate back by switching a load on the contactless card's coil or load modulation. Load modulation may be detected in the terminal's coil through interference. More generally, using the antenna(s) 318, processor 302, and/or the memory 306, the contactless card 101 provides a communications interface to communicate via NFC, Bluetooth, and/or Wi-Fi communications.

As explained above, transaction card 200 may be built on a software platform operable on smart cards or other devices having limited memory, such as JavaCard, and one or more or more applications or applets may be securely executed. Applet(s) 308 may be added to contactless cards to provide functionality, such as generating a one-time password (OTP) for multifactor authentication (MFA) in various mobile application-based use cases. Applet(s) 308 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 308 may be configured to encode the OTP as an NDEF type 4 well-known type text tag. In some examples, NDEF messages may comprise one or more records. The applet(s) 308 may be configured to add one or more static tag records in addition to the OTP record.

In some examples, the one or more applet(s) 308 may be configured to emulate an RFID tag. The RFID tag may include one or more polymorphic tags. In some examples, each time the tag is read, different cryptographic data is presented that may indicate the authenticity of the contactless card. Based on the one or more applet(s) 308, an NFC read of the tag may be processed, the data may be transmitted to a server, such as a server of the transaction system 106 via the computing device 104, and the data may be validated at the server.

In some examples, the transaction card 200 and server may include certain data such that the card may be properly identified. The transaction card 200 may include one or more unique identifiers (not pictured). Each time a read operation takes place, the counter(s) 312 may be configured to increment. In some examples, each time data from the transaction card 200 is read (e.g., by a mobile device), the counter(s) 312 is transmitted to the server for validation and determines whether the counter(s) 312 are equal (as part of the validation) to a counter of the server.

The one or more counter(s) 312 may be configured to prevent a replay attack. For example, if a cryptogram has been obtained and replayed, that cryptogram is immediately rejected if the counter(s) 312 has been read or used or otherwise passed over. If the counter(s) 312 has not been used, it may be replayed. In some examples, the counter that is incremented on the card is different from the counter that is incremented for transactions. The transaction card 200 is unable to determine the application transaction counter(s) 312 since there is no communication between applet(s) 308 on the transaction card 102.

In some examples, the counter(s) 312 may get out of sync. In some examples, to account for accidental reads that initiate transactions, such as reading at an angle, the counter(s) 312 may increment, but the application does not process the counter(s) 312. In some examples, when the mobile device is woken up, NFC may be enabled, and the device 110 may be configured to read available tags, but no action is taken responsive to the reads.

To keep the counter(s) 312 in sync, an application, such as a background application, may be executed that would be configured to detect when the mobile device 110 wakes up and synchronize with the server of a banking system indicating that a read that occurred due to detection to then move the counter 312 forward. In other examples, Hashed One Time Password may be utilized such that a window of mis-synchronization may be accepted. For example, if within a threshold of 10, the counter(s) 312 may be configured to move forward. But if within a different threshold number, for example within 10 or 1000, a request for performing re-synchronization may be processed, which requests via one or more applications that the user tap, gesture, or otherwise indicate one or more times via the user's device. If the counter(s) 312 increases in the appropriate sequence, then it possible to know that the user has done so.

The key diversification technique described herein with reference to the counter(s) 312, master key, and diversified key is one example of encryption and/or decryption a key diversification technique. This example key diversification technique should not be considered limiting of the disclosure, as the disclosure is equally applicable to other types of key diversification techniques.

During the creation process of the transaction card 200, two cryptographic keys may be assigned uniquely per card. The cryptographic keys may comprise symmetric keys that may be used in both encryption and decryption of data. Triple DES (3DES) algorithm may be used by EMV and it is implemented by hardware in the transaction card 200. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the transaction card 200 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances. The authentication message may be delivered as the content of a text NDEF record in hexadecimal ASCII format. In another example, the NDEF record may be encoded in hexadecimal format.

In embodiments, an applet(s) 308 may include a transaction applet that may be initiated or executed based on a detection of a transaction attempt. For example, the transaction applet may be configured to initiate when a transaction attempt is detected via one of the interface(s) 304, such as the EMV interface and/or the NFC interface. Based on the detection of the transaction attempt, the transaction applet may exchange data with another device, such as the transaction terminal to conduct a transaction. The data may include user identification information, account identification, card information (expiration date/CVV), and so forth. In embodiments, the transaction applet may exchange the information in a secure manner based on the standard for the interface. For example, the transaction applet may exchange information in accordance with the EMV standard or NFC standard based on the interface used for the transaction.

In embodiments, the applet(s) 308 may include a quality assurance applet configured to collect and/or exchange data corresponding to each transaction attempt. In embodiments, the quality assurance applet may be configured to detect a transaction attempt via an interface of the interface(s) 304. For example, the quality assurance applet may be a JavaCard applet and configured as a default applet to make it selectable or selected by default when the transaction card 200 enters a magnetic field of a transaction terminal or during initiation of an EMV exchange. The quality assurance applet may be set as a default applet on the transaction card 200 at the time of the manufacture and/or original programming of the transaction card 200 by installing the applet with the default parameter set. In this example, once the quality assurance applet is configured, changes to the quality assurance applet may be prohibited, e.g., the applet may be locked down. In some instances, the quality assurance applet may be set as a default applet after installation and may be reconfigurable. A Java operation, such as—make-default <AID> where AID is the quality assurance applet identifier, may be run on the quality assurance applet to make it a default applet to configure the applet as a default applet, for example.

In embodiments, the quality assurance applet may be configured such that once it is initiated, instructions are executed on the processor 302 and/or processing circuitry 316 of the transaction card 200 to determine data associated with a transaction attempt and store the data in memory 306. For example, the transaction card 200 may enter a magnetic field of an NFC reader or receive signals from an EMV device, and the quality assurance applet may determine data associated with the transaction attempt, such as a timestamp associated with the transaction attempt and an interface type of the interface (NFC interface, EMV interface, magstripe interface, etc.) on which the transaction attempt is detected. The data may further include a transaction identifier to identify the transaction attempt, and a transaction terminal identifier to identify a transaction terminal associated with the transaction attempt. The quality assurance applet may determine at least a portion of the data based on an exchange of information between the transaction card 200 and the transaction terminal. For example, the quality assurance applet may determine at least one of the timestamp, interface type, transaction identifier, and transaction terminal identifier from data received in the data exchange with the transaction terminal.

The quality assurance applet may store the data associated with the transaction attempt in the memory 306 of the transaction card 200. The data may be stored in a data structure in the memory, such as an array, and in a data format, such as ASCII. In some instances, the portion of the memory 306 for storing the data for the transaction attempts may be allocated at the time the quality assurance applet is installed on the transaction card 200, or the memory 306 may be allocated to the quality assurance applet as needed when the quality assurance applet is writing data to the memory 306. The quality assurance applet may store data associated with each transaction attempt until a read is performed to read the data from the memory 306, e.g., the data is transferred to a computing device 104 and/or server of the transaction system 106. The memory 306 may be cleared by the quality assurance applet once it is read from the memory 306 to ensure that all of the memory 306 is not used.

In embodiments, the quality assurance applet is configured to detect requests or reads for the data associated with the transaction attempts and stored in the memory 306. For example, the quality assurance applet may be configured to respond to one or more requests, such as near field data exchange requests, from a reader, such as a mobile NFC reader (e.g., of a mobile device or point-of-sale terminal). The quality assurance applet may generate one or more messages such as cryptogram messages in an NDEF format, e.g., an NDEF message that includes the data associated with the transaction attempts. In some instances, the quality assurance applet may encrypt the data prior to communicating with another device. The quality assurance applet may generate the encrypted data from the data associated with the transaction attempt stored in the memory 306 based on a cryptographic algorithm, a customer identifier, and a private key. For example, the quality assurance applet may apply the cryptographic algorithm, such as a 3DES algorithm, and utilize a customer identifier (or counter value) to generate diversified data and encrypt the data with a private key. The private key may be one of the keys assigned to the transaction card 200, as previously discussed. In other instances, the private key may be a session key that is uniquely generated for each communication. The session key may be generated by the quality assurance applet or another applet and derived by using the application transaction counter with one or more algorithms.

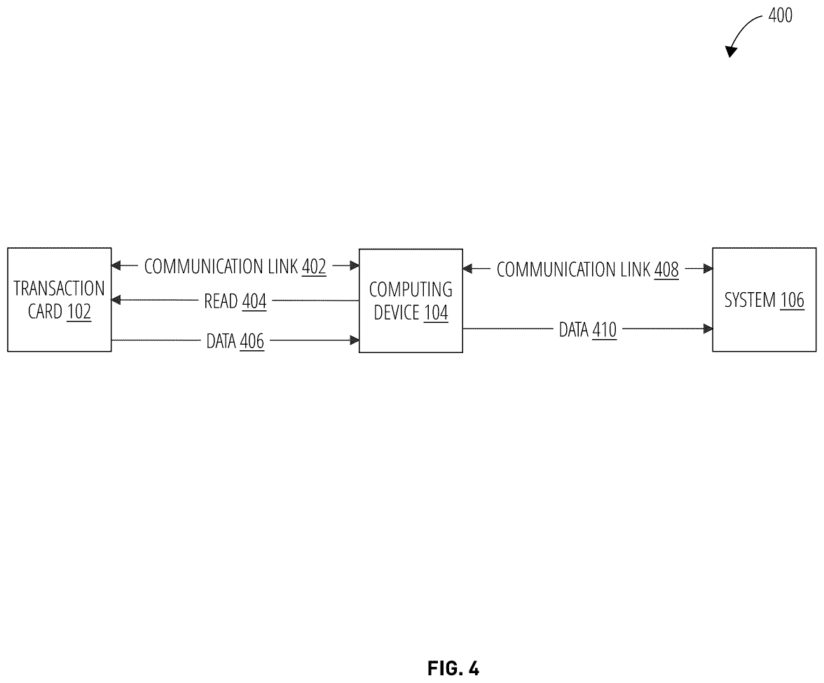

In embodiments, the quality assurance applet may provide the encrypted data to the computing device via the interface on which the read was detected. For example, the quality assurance applet may send a computing device the encrypted data in one or more NDEF messages. In some instances, the encrypted data may be provided in a batch communication. Note that, in some instances, the data may not be encrypted, and the quality assurance applet may provide the data in a raw or unencrypted format. FIG. 4 illustrates a detailed view of an exchange or sequence to communicate data between the transaction card 102 to computing device 104 and between the computing device and the transaction system 106.

FIG. 4 illustrates an example of a sequence flow 400 to communicate data according to one or more embodiments of the present disclosure. Sequence flow 400 may include a transaction card 102, the computing device 104, and the transaction system 106. In embodiments, the computing device 104 may include one or more applications, including mobile applications executable on a mobile platform such as Android or Apple IOS. In one example, the mobile application may be associated with a banking system, such as transaction system 106, and maybe a mobile banking application. The sequence flow 400 may be performed to communicate data associated with transaction attempts from the transaction card 102 to the computing device 104 and to the transaction system 106.

At line 402, the computing device 104 communicates with the transaction card 102 (e.g., after being brought near the transaction card 102) to establish a communication link. Communication between the computing device 104 and the transaction card 102 may involve the transaction card 102 being sufficiently close to a card reader (not shown) of the computing device 104 to enable NFC data transfer between the computing device 104 and the transaction card 102. Once the communication link is established between the computing device 104 and the transaction card 102, they may communicate the data associated with the transaction attempts between each other. The illustrated example includes communication via NFC data transfer; however, embodiments are not limited in this manner, and the data may be communicated using other methods, e.g., WiFi (802.11 standard(s)).

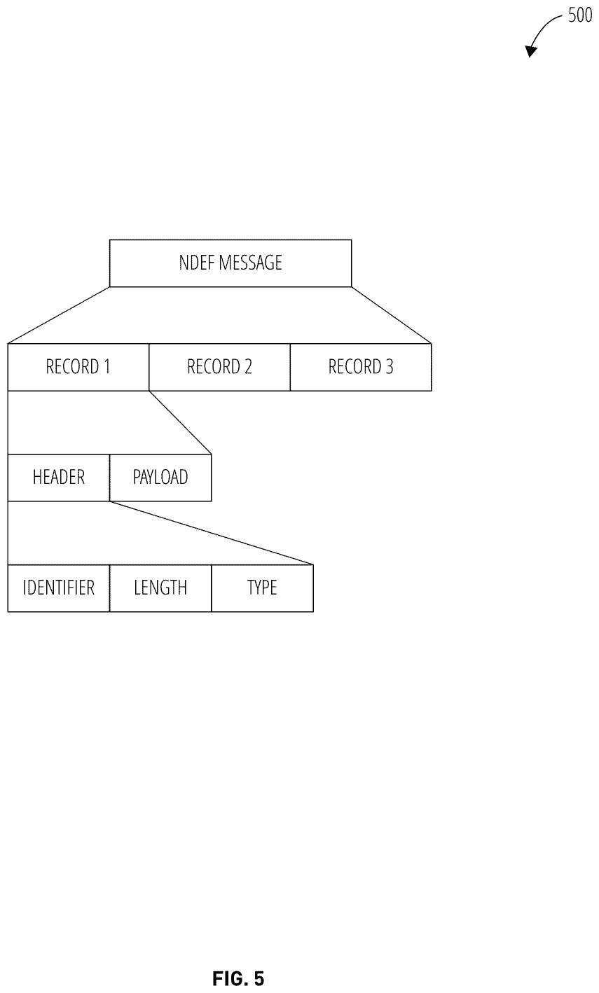

At line 404, the computing device 104 may generate a read message, such as an NFC read of an NDEF tag, which may be created in accordance with the NFC Data Exchange Format. The transaction card 102, including the quality assurance applet, may detect the read and initiate one or more instructions to generate data in response to the read message. Specifically, and at line 406, the transaction card 102, including the quality assurance applet, may retrieve the data associated with the transaction attempts to send to the computing device 104. In embodiments, the quality assurance applet may generate one or more NDEF messages, as similarly illustrated in FIG. 5, and include the data associated with the transaction attempts in the payloads of the message(s). The data may be an encrypted or unencrypted format in the NDEF messages. The transaction card 102 may communicate the data in the NDEF messages to the computing device 104.

In embodiments, the computing device 104 may establish a communication link with the transaction system 106 at line 408. The computing device 104, may include a mobile application or programming code configured to establish a secure communication link with the transaction system 106 via one or more wireless and wired network connections. The communication link in accordance with one or more WiFi and/or cellular standards and may be a secure communication link.

At line 410, the computing device 104 may communicate the data for the transaction attempts to the transaction system 106. In embodiments, the transaction system 106 may receive the data associated with the transaction attempts and store the data in a data structure of a database. The transaction system 106 may utilize the data along with data of actual transactions performed to detect issues with respect to transaction cards and/or transaction terminals, as will discussed in further detail below.

FIG. 5 illustrates an example NDEF message 500 to communicate data between a transaction card 102 and another device, such as a computing device 104 or transaction terminal(s) 108. In embodiments, the NDEF message 500 may include a number of records that may be configured in accordance with the NDEF format in a ISO-1443 infrastructure. Further, each of the records may have a header and a payload, and the header includes an identifier of the record, a length of the record, and a type of the record. In embodiments, the type may specify the kind of content the record contains, for example. If type is set to: 0—Empty: the record doesn't contain any information, 1—well known: the data is defined by the Record Type Definition (RTD) specification, 2 Multipurpose Internet Mail Extensions (MIME): a data type as defined by RFC 2046, 3—Absolute Uniform Resource Identifier (URI): is a pointer to a resource that follows the RFC 3986 syntax, 4—External: a user-defined data that relies on the format specified by the RTD specification, 5—Unknown: data type is unknown, 6—Unchanged: a chunk of record, and 7—Reserved-a reserve value.

An NDEF message 500 can contain multiple records. The first record in a message has the MB (message begin) flag set to true to indicate the first record. The last record in the message has the ME flag set to indicate the last record. All the intermediate records have both the MB and the ME flags set to false.

In embodiments, the NDEF message 500 may include a Type Length field contains the length of the payload type in bytes. The payload type specifies the precise kind of data found in the payload. The Payload Length field contains the length of the payload in bytes. A record may contain up to 4,294,967,295 bytes (or 2\hat{ }32-1 bytes) of data.

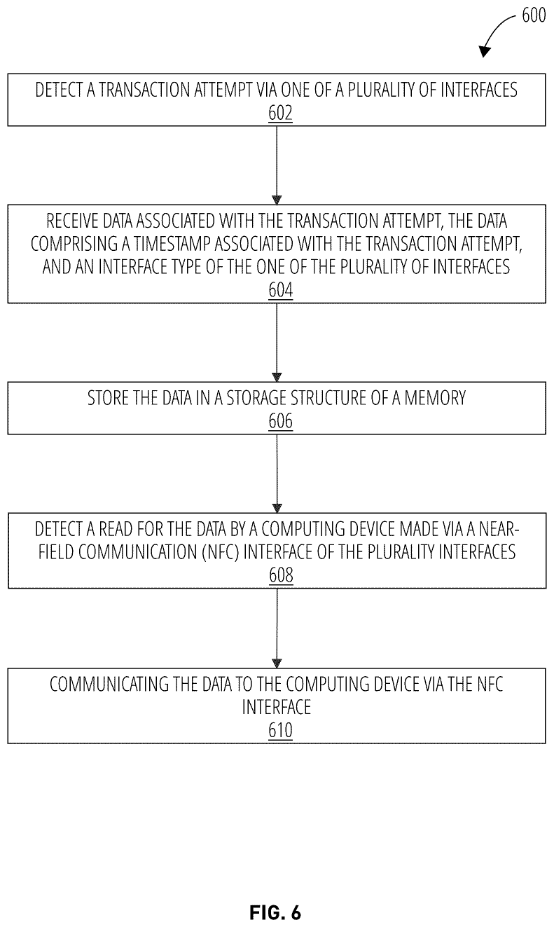

FIG. 6 illustrates an example logic flow 600 that may be performed by a computing device, such as processing circuitry of a transaction card. In one example, the operations of logic flow 600 may be performed by an applet, such as the quality assurance applet, executing on the circuitry of the transaction card. Logic flow 600 illustrates one possible set of operations that may be performed by an applet to collect and store data for transaction attempts, successful and unsuccessful. In some instances, the quality assurance applet may include software instructions programmed in accordance with the JavaCard programming language. However, embodiments are not limited in this manner and operations discussed herein may be programmed and/or execute in accordance with other languages such as extendable markup language (XML), and languages such as C, Perl, C++, assembly, and so forth.

At block 602, the logic flow 600 includes detecting a transaction attempt via one of a plurality of interfaces. For example, the quality assurance applet may be configured as a default applet and may be initiated upon detection via the NFC interface or an EMV interface. Specifically, the quality assurance applet may be initiated when the transaction card including the NFC interface detects electromagnetic signals or a communication exchange is initiated via the EMV interface.

At block 604, logic flow 600 includes determining data associated with the transaction attempt. The data may be received via one or more communication exchanges with another device via an interface or determined based on data on the transaction card itself. For example, the quality assurance applet may receive from a transaction terminal data such as a timestamp associated with the transaction attempt, a transaction terminal identifier associated with the transaction terminal, a transaction identifier to identify the transaction attempt, an indication whether the transaction attempt was successful or unsuccessful, an interface type for the transaction attempt, and so forth. The applet may also determine the data from the transaction card. For example, the quality assurance applet may determine a timestamp from a clock of the transaction card, an interface type based on the transaction attempt detection, a transaction identifier generated by the transaction card, etc.

At block 606, logic flow 600 includes storing the data in a storage structure of memory. For example, the quality assurance applet may store the data in an array including blocks of the memory, and the data may also be stored such that it is associated with the transaction attempt. Thus, each transaction attempt may correspond with a particular set of data.

The logic flow 600, at block 608, incudes detecting a request for the data associated with the transaction attempt(s). For example, the quality assurance applet may detect a read for the data by a computing device made via a Near-Field Communication (NFC) interface of the transaction card. The read may be received from a computing device, such as a mobile device of a user after a communication channel is established between the computing device and the transaction card. Establishment of the channel may include performing one or more verification and validation routines.

At block 610, the logic flow 600 includes communicating the data to the computing device via the NFC interface. The quality assurance applet may generate one or more NDEF messages, including records having the data associated with the transaction attempts in payloads and communicate the NDEF messages to the other computing device. In some instances, the quality assurance applet may encrypt the data. For example, the quality assurance applet may utilize a cryptographic algorithm, a customer identifier, and a key (private key or shared key) to generate encrypted data to share with the other computing device.

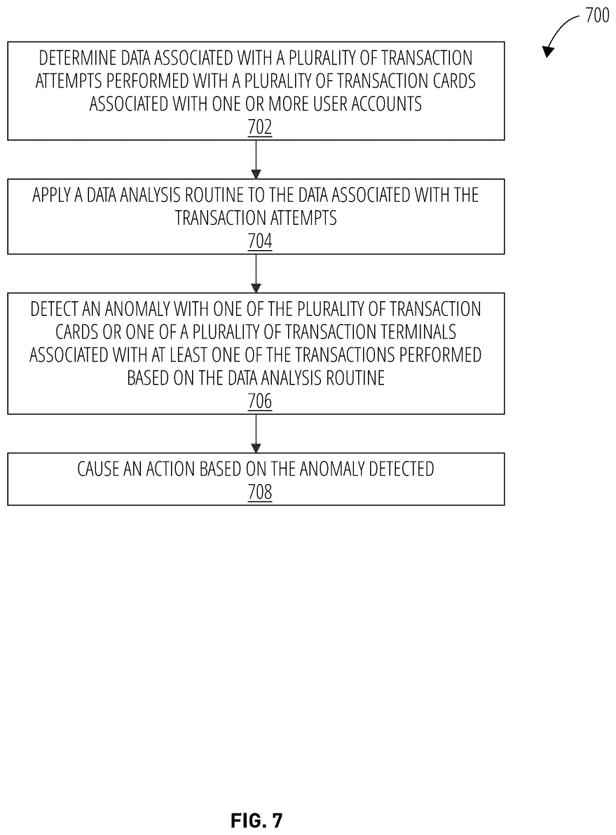

FIG. 7 illustrates a logic flow 700 that may be performed by one or more systems, such as a transaction system, to detect anomalies and issues with transaction cards and transaction terminals. The operations of FIG. 7 may be performed by a system including one or more servers including processors and memory to execute instructions to detect the anomalies based on data collected by transaction cards and transaction terminals. The data may correspond with transaction attempts, both successful and unsuccessful.

At block 702, the logic flow 700 includes determining data associated with a plurality of transaction attempts performed with a plurality of transaction cards associated with user accounts. The data may have been collected by the one or more transaction cards, as previously discussed, or by one or more transaction terminals. In one example, data may be collected by a transaction card each time a transaction attempt is performed with the transaction card. In another example, the data may be collected by a transaction terminal and provided to a transaction system during the processing of a transaction, e.g., when a user is using a transaction card for a good or service. The data may include timestamp data, transaction terminal identifier data, transaction identifier data, interface type data, user account data, and so forth for each transaction attempt.

At block 704, the logic flow 700 includes applying one or more data analysis routines or processing to the data. The data analysis routine may compare the data to determine any number of usage statistics including a number of times a user or customer encounter contactless (NFC) transaction terminals, a number of times a user takes advantage of the NFC transaction terminal with a contactless (NFC) payment, a number of times a customer encounters a contactless payment terminal and falls back to a contact (EMV/Swipe) payment, and a number of times a transaction attempt fails indicating a user “gave up.” This data may be used to detect issues with transaction cards and terminals.

In embodiments, the data analysis routine may detect a pattern of a user attempting to utilize NFC interface to perform the transaction, the transaction attempt failing, and the user switching to another method (swipe or EMV interface) to perform the transaction. This pattern may be detected based on consecutive transaction attempts having close timestamps (within a configurable reattempt transaction threshold) at a transaction terminal multiple times for the transaction card, e.g., an attempt corresponding to an NFC interface and one corresponding to an EMV interface. The transaction system may determine that there is an anomaly or an issue with the NFC interface with the transaction card if the pattern occurs with the same transaction card at different transaction terminals. Similarly, the data analysis routine may determine there is an issue with a transaction terminal if a similar pattern is detected at the same transaction terminal, but with different transaction cards. More specifically, the transaction system may detect consecutive transaction attempts having close timestamps at a transaction terminal multiple times for multiple transaction cards (above a configurable reattempt transaction threshold). The routine may detect anomalies based on other statistics. For example, if a user uses his/her transaction card NFC interface statistically less than other like users, e.g., same area, gender, age group, etc. In another example, the transaction system may determine there is an issue or anomaly with a transaction terminal if it is being used in a statistically different way than like terminals, e.g, in the same location, same type of place/establishment, etc.

The transaction system may include perform the data analysis routine including performing a statistical analysis on the data include scoring the data with a model to detect anomalies with the transaction cards and/or terminals. For example, the data analysis routine may include applying supervised or unsupervised machine-learning techniques to detect patterns in the data that may indicate an issue with a transaction card or terminal. The machine-learning may include training one or more models with known data set (created/generated) or with real data sets to detect the patterns. Embodiments are not limited in this manner.

At block 706, the logic flow 700 includes detecting the anomaly or issue based on the data analysis routine applied to the data. For example, the transaction system may determine there is a problem with a transaction card or a transaction terminal. Further and at block 708, the logic flow 700 includes causing an action to performed based on the detected anomaly. For example, the transaction system may cause a new transaction card to be issued to a user if the system determines an issue with an interface for a transaction. In another example, the transaction system may send instructions on a proper way to use an NFC interface if the system determines that the NFC interface is working properly, but the user appears to not know how to use it correctly, e.g., based on periodic successful attempts. In a third example, the transaction system may send an indication to an operator of a transaction terminal, indicating that an interface is malfunctioning and/or is incorrectly configured. Embodiments are not limited to these examples, and other remedial operations may be performed.

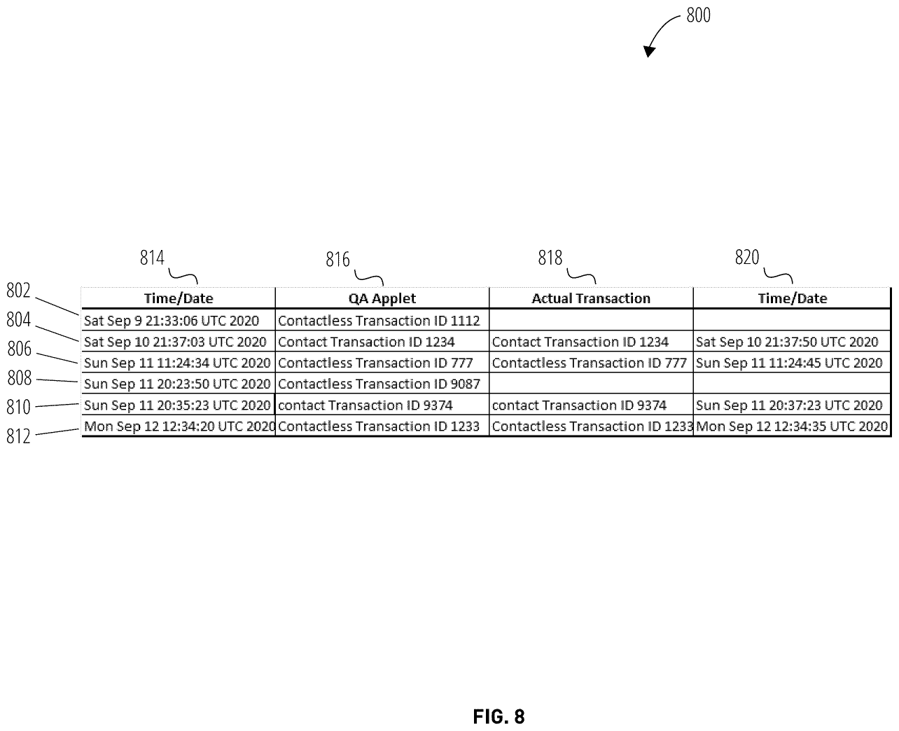

FIG. 8 illustrates an example of data 800 corresponding to transaction attempts for a transaction card. The illustrated data 800 includes a number of entries corresponding to transaction attempts, and each row corresponds to a particular transaction attempt. In embodiments, column 814 includes timestamp data (time/date) data for transaction attempts detected and saved by the quality assurance applet on the transaction card. Column 816 includes additional data detected and stored by the quality assurance applet. The data in column 816 may include an interface type and a transaction identifier. In some embodiments, the data in column 816 may include a transaction terminal identifier (not shown). Column 818 includes data corresponding to actual transactions processed by the transaction system. The data in column 818 also includes interface type and transaction identifier for the transaction. The data may also include a transaction terminal identifier. Column 820 includes timestamp data corresponding to the actual transactions of column 818.

The data 800 may also include a number of rows, and each row may correspond to a particular transaction attempt, successful or unsuccessful, detected and stored by the quality assurance applet. For example, rows having data in column 814 and 816, but no data in columns 818 and 820 indicate that a transaction attempt was recorded by the quality assurance applet, but was not performed by the transaction system. For example, row 802 includes data in columns 814 and 816, but no data in 818 and 820; and therefore a transaction attempt may have occurred, but not actually performed by the transaction system. The transaction system may apply a data analysis routine and determine that this pattern indicates that there is an issue with a user's transaction card. In some instances, the transaction system may be configured to require that a threshold number of a pattern may need to occur before an anomaly or issue is indicated. For example, the transaction system may require that five or more instances similar to row 802, are required before the transaction system determines that there is an anomaly or issue.

Row 804 indicates another pattern that may be detected by the transaction system. The data in row 804 indicates that both the quality assurance applet and the transaction system processed a contact transaction (EMV interface or magstripe interface) with the transaction identifier. Although the timestamps are slightly different, the transaction system may determine that they are within an acceptable threshold and that the data detected by the quality assurance applet and the transaction system are for the same transaction. Row 806 indicates a similar pattern. However, in this example, the transaction is performed with a different interface, such as the NFC interface.

Row 808 indicates that the quality assurance applet detected and stored data for a transaction attempt utilizing the contactless interface. However, the transaction system did not receive a corresponding transaction for the transaction attempt in row 808. Row 810 includes a transaction attempt corresponding to a transaction performed by the transaction system. Note that the transaction attempt of row 810 occurred after the transaction attempt detected in row 808. This pattern may indicate that a user attempted to perform a transaction via the contactless interface (row 808), but the transaction attempt failed, and the user utilizes a contact interface to perform the transaction (row 810). The transaction system may determine that this pattern indicates that there is an anomaly or issue with the contactless interface of the transaction card and/or of the transaction terminal. The issue may be that the customer is incorrectly using the contactless interface, the terminal is incorrectly configured, or that there is a malfunction with one of or both of the card and terminal.

Row 812 indicates that a contactless transaction attempt was successfully performed with the transaction card. Since this transaction attempt occurred after the failed attempt of row 808, the transaction system may determine that the transaction card's contactless interface is working properly. The transaction system may determine that the issue detected in rows 808 and 810 are with the transaction terminal and/or in the proper attempt by the user. Embodiments are not limited to these examples, and a previously discussed the transaction system may detect a number of patterns and may utilize machine-learning and modeling.

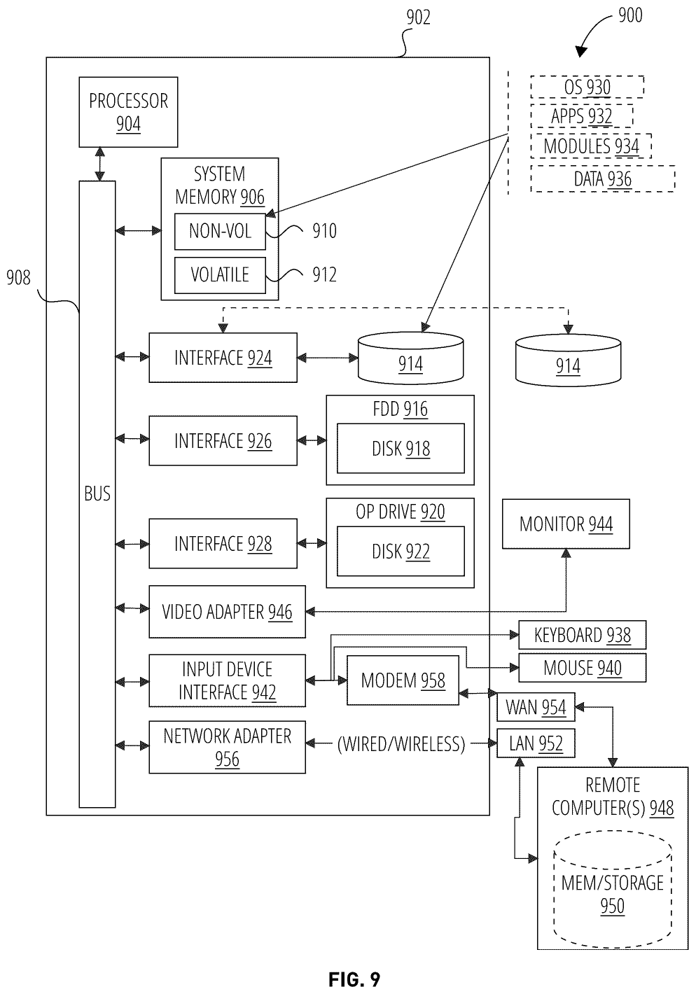

FIG. 9 illustrates an embodiment of an exemplary computer architecture 900 suitable for implementing various embodiments as previously described. In one embodiment, the computer architecture 900 may include or be implemented as part of system 100, transaction system 106, and the transaction terminal(s) 108.

As used in this application, the terms “system” and “component” are intended to refer to a computer-related entity, either hardware, a combination of hardware and software, software, or software in execution, examples of which are provided by the exemplary computing computer architecture 900. For example, a component can be but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computer architecture 900 includes a processor 904, a system memory 906 and a system bus 908. The processor 904 can be any of various commercially available processors.

The system bus 908 provides an interface for system components including, but not limited to, the system memory 906 to the processor 904. The system bus 908 can be any of several types of bus structure that may further interconnect to a memory bus (with or without a memory controller), a peripheral bus, and a local bus using any of a variety of commercially available bus architectures. Interface adapters may connect to the system bus via slot architecture. Example slot architectures may include without limitation Accelerated Graphics Port (AGP), Card Bus, (Extended) Industry Standard Architecture ((E) ISA), Micro Channel Architecture (MCA), NuBus, Peripheral Component Interconnect (Extended) (PCI (X)), PCI Express, Personal Computer Memory Card International Association (PCMCIA), and the like.

The computing architecture 100 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 906 can include non-volatile 910 and/or volatile 912. A basic input/output system (BIOS) can be stored in the non-volatile 910.

The computer 902 may include various types of computer-readable storage media in the form of one or more lower speed memory units, including an internal (or external) hard disk drive 914, a magnetic disk drive 916 to read from or write to a removable magnetic disk 918, and an optical disk drive 920 to read from or write to a removable optical disk 922 (e.g., a CD-ROM or DVD). The hard disk drive 914, magnetic disk drive 916 and optical disk drive 920 can be connected to system bus 908 the by an HDD interface 924, and FDD interface 926 and an optical disk drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 910, and volatile 912, including an operating system 930, one or more applications 932, other program modules 934, and program data 936. In one embodiment, the one or more applications 932, other program modules 934, and program data 936 can include, for example, the various applications and/or components of the systems discussed herein.

A user can enter commands and information into the computer 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 904 through an input device interface 942 that is coupled to the system bus 908 but can be connected by other interfaces such as a parallel port, IEEE 1394 serial port, a game port, a USB port, an IR interface, and so forth.

A monitor 944 or other type of display device is also connected to the system bus 908 via an interface, such as a video adapter 946. The monitor 944 may be internal or external to the computer 902. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all the elements described relative to the computer 902, although, for purposes of brevity, only a memory and/or storage device 950 is illustrated. The logical connections depicted include wire/wireless connectivity to a local area network 952 and/or larger networks, for example, a wide area network 954. Such LAN and WAN networking environments are commonplace in offices and companies, and facilitate enterprise-wide computer networks, such as intranets, all of which may connect to a global communications network, for example, the Internet.

When used in a local area network 952 networking environment, the computer 902 is connected to the local area network 952 through a wire and/or wireless communication network interface or network adapter 956. The network adapter 956 can facilitate wire and/or wireless communications to the local area network 952, which may also include a wireless access point disposed thereon for communicating with the wireless functionality of the network adapter 956.

When used in a wide area network 954 networking environment, the computer 902 can include a modem 958, or is connected to a communications server on the wide area network 954 or has other means for establishing communications over the wide area network 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory and/or storage device 950. It will be appreciated that the network connections shown are exemplary and other means of establishing a communications link between the computers can be used.

The computer 902 is operable to communicate with wire and wireless devices or entities using the Institute of Electrical and Electronics Engineers (IEEE) 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.118 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. XXX may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

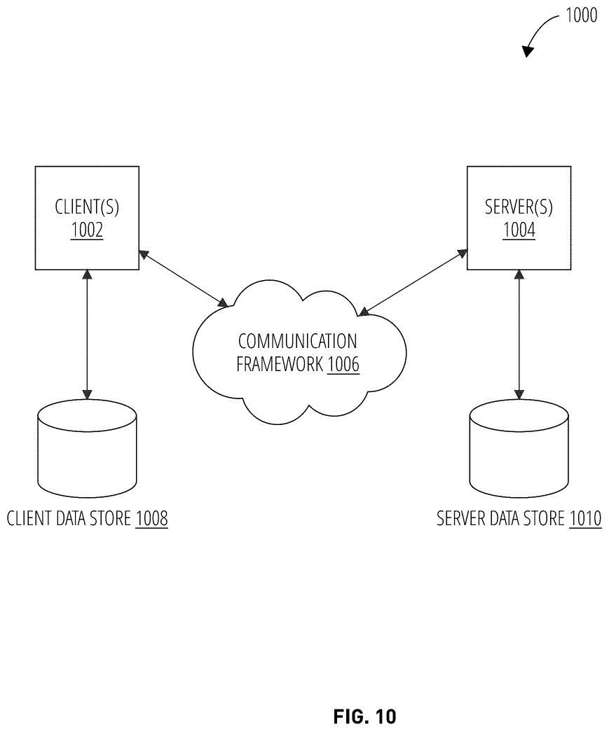

FIG. 10 is a block diagram depicting an exemplary communications architecture 1000 suitable for implementing various embodiments as previously described. The communications architecture 1000 includes various common communications elements, such as a transmitter, receiver, transceiver, radio, network interface, baseband processor, antenna, amplifiers, filters, power supplies, and so forth. The embodiments, however, are not limited to implementation by the communications architecture 1000, which may be consistent with computing system 100.

As shown in FIG. 10, the communications architecture 1000 includes one or more client(s) 1002 and server(s) 1004. The server(s) 1004 may implement one or more devices of computing system 100. The client(s) 1002 and the server(s) 1004 are operatively connected to one or more respective client data store 1008 and server data store 1010 that can be employed to store information local to the respective client(s) 1002 and server(s) 1004, such as cookies and/or associated contextual information.

The client(s) 1002 and the server(s) 1004 may communicate information between each other using a communication framework 1006. The communication framework 1006 may implement any well-known communications techniques and protocols. The communication framework 1006 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1006 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.11 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 1002 and the server(s) 1004. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

What is claimed is:

1. A transaction card, comprising:
a plurality of interfaces;
a processor; and
a memory storing instructions which when executed by the processor, cause the processor to:
detect, by a quality assurance applet executing on the processor, a transaction attempt via an interface of the plurality of interfaces;
determine, by the quality assurance applet, data associated with the transaction attempt, the data comprising a timestamp associated with the transaction attempt, and an interface type of the interface on which the transaction attempt was detected;
store, by the quality assurance applet, the data associated with the transaction attempt in the memory;
detect, by the quality assurance applet, a read for the data by a computing device made via the interface of the plurality interfaces;
generate, by the quality assurance applet, encrypted data from the data associated with the transaction attempt stored in the memory, the encrypted data generated based on a cryptographic algorithm, a customer identifier, and a private key; and
provide, by the quality assurance applet, the encrypted data to the computing device via the interface on which the read was detected.

2. The transaction card of claim 1, wherein the interface on which the transaction attempt is detected is one of a contact interface or a contactless interface, the contact interface comprising a magstripe interface or an EMV interface, and the contactless interface comprising a near-field communication (NFC) interface.

3. The transaction card of claim 1, wherein the quality assurance applet is configured as a default applet on the transaction card to enable detection of the transaction attempt.

4. The transaction card of claim 1, wherein the data associated with the transaction attempt further comprises a transaction identifier to identify the transaction attempt, and a transaction terminal identifier to identify a transaction terminal.

5. The transaction card of claim 4, wherein the detection of the transaction attempt includes receiving at least a portion of the data from the transaction terminal, the portion of the data comprising the timestamp, the interface type, or combination thereof.

6. The transaction card of claim 1, wherein the data associated with the transaction attempt is stored with other data corresponding with other transaction attempts.

7. The transaction card of claim 6, wherein the encrypted data further comprises other data corresponding to the other transaction attempts, and the processor to provide the encrypted data including the data and the other data to the computing device as a batch communication.

8. The transaction card of claim 1, wherein the interface on which the read is detected, and the encrypted data is provided is a near-field communication (NFC) interface, and the encrypted data is provided in one or more NFC Data Exchange Format (NDEF) messages.

9. A transaction system comprising:
a processor;
storage comprising a data store; and
a memory storing instructions which when executed by the processor, cause the processor to:
receive, via an interface coupled with the processor, data associated with a plurality of transaction attempts performed with a transaction card associated with a user account, the data comprising entries associated with transaction attempts, each entry for each transaction attempt including a timestamp for a corresponding transaction attempt, and an interface type for the transaction attempt;
store the data in the data store;
determine interface information for one or more interfaces of the transaction card based on the data, the interface information to indicate anomalies and interface usage statistics associated with the one or more interfaces; and
cause an action based on the interface information.

10. The system of claim 9, wherein the data is encrypted and received from the transaction card via a computing device communicatively coupled via the interface.

11. The system of claim 9, wherein each entry associated with each of the transaction attempts includes a transaction identifier, and a point-of-sale (POS) identifier to identify a POS terminal.

12. The system of claim 9, the processor to:
compare timestamps of consecutive transaction attempts in the data;
determine that a difference between the timestamps is within a reattempt transaction threshold;
determine an interface type associate with a first in-time transaction attempt of the consecutive transaction attempts; and
indicate a failed transaction attempt in an entry corresponding to the first in-time transaction attempt.

13. The system of claim 9, wherein the usage statistics indicate a number of failed transaction attempts correspond with an interface of the transaction card.

14. The system of claim 9, wherein the usage statistics indicate a number of transaction attempts utilizing a contact interface and a number of transaction attempts utilizing a contactless interface.

15. The system of claim 14, wherein the usage statistics indicate whether each of the transaction attempts for the contact interface and the contactless interface was successful or not successful.

16. The system of claim 9, the processor to:
receive additional data associated with a plurality of transaction cards and user accounts;
store the additional data in the data store;
determine interface information for the plurality of transaction cards based on the data; and
determine an anomaly associated with a POS terminal based on the interface information for the plurality of transaction cards.

17. The system of claim 16, wherein the action comprises sending a device associated with the POS terminal an indication of the anomaly.

18. The system of claim 9, wherein the action comprises sending a user associated with the user account a replacement transaction card, communicating a text message to a device associated with the user account, or sending instructions to perform a contactless interface transaction to the device associated, or combination thereof.

19. A computer-implemented method, comprising:
detecting, by a quality assurance applet executing on a processor, a transaction attempt via one of a plurality of interfaces;
receiving, by the quality assurance applet, data associated with the transaction attempt, the data comprising a timestamp associated with the transaction attempt, and an interface type of the one of the plurality of interfaces;
storing, by the quality assurance applet, the data in a storage structure of a memory;
detecting, by the quality assurance applet, a read for the data by a computing device made via a Near-Field Communication (NFC) interface of the plurality interfaces;
encrypting, by the quality assurance applet, the data associated with the transaction attempt utilizing a cryptographic algorithm, a customer identifier, and a private key; and
causing communication, by the quality assurance applet, of the data to the computing device via the NFC interface.

20. The computer-implemented method of claim 19, wherein the interface on which the transaction attempt is detected is one of a contact interface or a contactless interface, the contact interface comprising a magstripe interface or an EMV interface, and the contactless interface comprising the NFC interface.
